(19) United States
(12) Patent Application Publication
(10) Pub. No.: US 2011/0153331 A1
(43) Pub. Date: Jun. 23, 2011

(54) Method for Generating Voice Signal in E-Books and an E-Book Reader

(75) Inventors: Yuan-Hua DONG, SHANGHAI CITY (CN); Liang HUANG, SHANGHAI CITY (CN); Shih-Kuang TSAI, SHANGHAI CITY (CN)

(73) Assignee: INVENTEC APPLIANCES CORP., TAIPEI HSIEN (TW)

(21) Appl. No.: 12/779,880

(22) Filed: May 13, 2010

(30) Foreign Application Priority Data
Dec. 18, 2009 (TW) 98143751

(51) Int. Cl. G10L 21/00; G06F 3/041; G06F 3/048

(52) U.S. Cl. 704/270; 345/173; 715/835; 704/E21.001

(57) ABSTRACT

The present invention provides a method for generating voice signal in electronic books (E-books). The method includes the steps of: receiving a voice signal in response to a triggering signal for placing a bookmark; and displaying a functional icon of the bookmark corresponding to the voice signal in a region of the E-book. The present invention also provides a E-book reader, including: a display unit, a receiver unit, and a processing unit, wherein the receiver unit receivers a voice signal in response to a triggering signal for placing a bookmark, and the processing unit is used to display a functional icon of the bookmark corresponding to the voice signal in a region of the E-book.

### RELATED APPLICATIONS

This application claims priority to Taiwan Application Serial Number 98143751, filed Dec. 18, 2009, which is herein incorporated by reference.

### FIELD OF INVENTION

The present invention relates to an electronic bookmarker. More particular, the present invention relates to a method for generating voice signal in the electronic bookmarker.

### BACKGROUND ART

Electronic books (E-books) stored in personal computers or handheld devices are usually provided with a bookmark function for adding/creating an electronic bookmark. Currently, such bookmarkers are created by inputting texts via a keyboard or a handwriting input panel. The electronic bookmark may act like a bookmark in a conventional book, that is, the electronic bookmark may mark a page of the book or a section of the page so that the user can easily return to that page/section after closing the book or moving to another page/section. Furthermore, the electronic bookmark may be used to make a remark or memo in the form of a word processing document. These features of the electronic bookmark may improve the user's reading experience and satisfaction.

However, the above-identified input means has the disadvantage that the speeds of the inputting and/or identification are usually slow, especially for users whose native languages are not English. The flash of inspiration is usually fleeting; hence, making an electronic bookmark with the conventional inputting means may not be able to timely capture the thoughts in detail. Possibly even worse, users may be unwilling to create the electronic bookmarks due to the inconvenience and complexity of the available inputting techniques.

### SUMMARY OF THE INVENTION

Aiming at the above-described defects regarding the conventional techniques for creating electronic bookmarks, the present invention provides a method for generating a voice signal in E-books and an E-book reader.

In one aspect, the present invention is directed to a method for generating a voice signal in E-books. The method is applicable to an E-book reader that is operable to display E-books. The method includes the steps as follows. First, a voice signal can be received in response to a triggering signal for placing a bookmark. And then, a functional icon of the bookmark corresponding to the voice signal is displayed in a region of the E-book.

In one embodiment, after displaying the functional icon in the region of the E-book, the method further comprises a step of playing the voice signal when the functional icon is selected.

In another embodiment, after displaying the functional icon in the region of the E-book, the method further comprises a step of presenting information corresponding to the voice signal when the functional icon is selected, wherein the information comprises information about time when the voice signal is recorded, a user who generates or causes the recording of the voice signal, or an importance level of the voice signal.

In one embodiment, the method further comprises receiving a second voice signal in response to a triggering signal after the functional icon is displayed in the region. Further, a second functional icon is displayed, which is corresponding to the second voice signal in a region of the E-book. Preferably, the second functional icon corresponds to the voice signal and the second voice signal. Preferably, the second functional icon encompasses the functional icon. In further embodiments, the voice signal is received when a button of the E-book is pressed. And the voice signal is recorded when the button is pressed once again.

In further embodiments, when the E-book is displayed on a touch screen of the E-book reader and the region of the E-book is clicked, the triggering signal is generated. In one embodiment, the step of receiving the voice signal comprises: encoding and storing the voice signal.

In another aspect, the present invention is directed to an E-book reader, which comprises a display unit, a receiving unit, and a processing unit. Specifically, the display unit is operable to display an E-book, and the receiving unit is operable to receive a voice signal in response to a triggering signal for placing a bookmark. And the processing unit displays a functional icon of the bookmark corresponding to the voice signal in a region of the E-book.

In one embodiment, the E-book reader further comprises a play unit, which is configured to play the voice signal after the functional icon is selected.

In another embodiment, the E-book reader further comprises a presentation unit, which presents information corresponding to the voice signal after the funcitonal icon is selected. The information comprises information about time when the voice signal is recorded, a user who generates or causes the recording of the voice signal, or an importance level of the voice signal.

The receiving unit is used to receive a second voice signal in response to a triggering signal after the functional icon is displayed in the region. Further, a second functional icon is displayed, which is corresponding to the second voice signal in a region of the E-book. Preferably, the second functional icon corresponds to the voice signal and the second voice signal. Preferably, the second functional icon encompasses the functional icon

In one embodiment, when the E-book is displayed on a touch screen of the display unit and the region of the E-book is clicked, the triggering signal is generated.

### BRIEF DESCRIPTION OF THE DRAWINGS

These and other features of the invention will become more apparent from the following description in which reference is made to the appended drawings, wherein:

FIG. 1 is an exemplary flow chart illustrating the method for generating a voice signal according to one embodiment of the invention; and

FIG. 2 is a block diagram illustrating an E-book reader according to one embodiment of the invention.

### PREFERRED EMBODIMENTS OF THE INVENTION

One or more currently preferred embodiments have been described by way of example. It will be apparent to the skilled in the art that a number of variations and modifications can be made without departing from the scope of the invention as defined in the claims.

In one exemplary embodiment of the present invention, the electronic bookmark differs from the conventional electronic bookmark at least in that the electronic bookmark provided herein employs a voice input means rather than the text-input means adopted in the conventional art. As compared with text input, voice input enables rapid and convenient input.

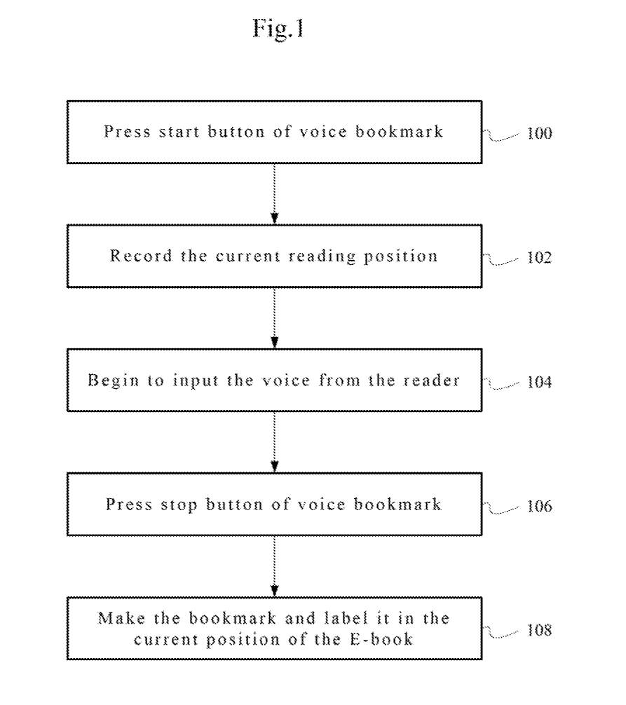

Reference is made to FIG. 1 to describe the method for generating a voice signal for use as the electronic bookmark in detail. FIG. 1 is an exemplary flow chart illustrating the method for generating a voice signal according to the embodiments of the invention. Briefly, according to the voice signal generation method provided herein, the voice of the reader is recorded between the first and second triggering of a shortcut key; then, the electronic voice bookmark is processed by a voice encoder and a central processor unit; and then, the electronic voice bookmark is stored in the non-volatile memory. The electronic voice bookmark is closely associated with the reader's present reading section/page so that, for example, the reader may search and sort/arrange a plurality of electronic voice bookmarks according to the page and line associated therewith.

Referring to FIG. 1, in step 100, the reader starts to read the E-book with an E-book reader system, and prepares to make an electronic bookmark at any time so as to record the reader's remarks or thoughts. If the reader does not want to create the electronic voice bookmark, the reader may continue to read the E-book; otherwise, the reader may press the shortcut key or button (such as a “Start” key) for triggering the process for generating an electronic voice bookmark. After the shortcut key is pressed, a triggering signal is sent. Afterwards, in step 102, the system will record the position of the reader's current reading section such as the page and/or line number of the section. In step 104, the system starts to record the reader's voice and receives the voice in response to the aforesaid triggering signal. Such voice may be thoughts and remarks regarding the content of the E-book, or may be notes regarding the reading time. The recording step (104) is stopped by pressing a shortcut key or button (such as a “Stop” key) for triggering a stop signal for terminating the recording step. In step 106, the recorded voice is stored in the system after the recording step ends. It should be understood by those skilled in the art that the above-described start key and stop key may actually be the same key. In this case, when the shortcut key is pressed once, the system sends the triggering signal, records the reader's current reading section, and records the voice of the reader; when the shortcut key is pressed once again, the system sends a stop signal and stores the recorded voice. The voice data recorded between the first and second pressing of the shortcut key may be used as the voice signal of the electronic bookmark of the electronic book. The method proceeds to step 108 after the system receives the stop signal. In step 108, the electronic bookmark is created, and then, a mark is presented in a position in adjacent to the current reading section of the E-book. For example, the recorded voice for use as an electronic voice bookmark may be stored in the non-volatile memory built-in the E-book reader system. The electronic voice bookmark can be copied, deleted or searched together with the position of the current reading section. The position of current reading section may be presented as the page number of the section, page and line numbers of the section, or a specific position in a specific line. For example, the electronic bookmark may be presented as a functional icon.

It should be noted that according to the method for generating a voice signal of the present invention, a single bookmark or a plurality of bookmarks may be generated at any given region of the recorded-book. In one example concerning a single bookmark, the system first receives a triggering signal; then, the system receives a voice signal in response to the triggering signal; and then, the system presents a functional icon of the bookmark corresponding to the voice signal in a specific region of the E-book. For instance, the voice signal is corresponding to a functional icon. In another example concerning multiple bookmarks, the system first receives a triggering signal after a functional icon has been displayed in a specific region. In this case, a second voice signal is received in response to the triggering signal. Then, a second functional icon is displayed in the above-mentioned region such that the second functional icon is corresponding to both the voice signal and the second voice signal. In other words, the second functional icon may be used to represent not only a first bookmark corresponding to the functional icon, but also a second bookmark corresponding to the second functional icon.

In one embodiment, the second functional icon may be configured as a function menu. Therefore, the reader can select a first bookmark corresponding to the voice signal or a second bookmark corresponding to the second voice signal from the function menu, when the user is reading the section associated with any one of the bookmarks.

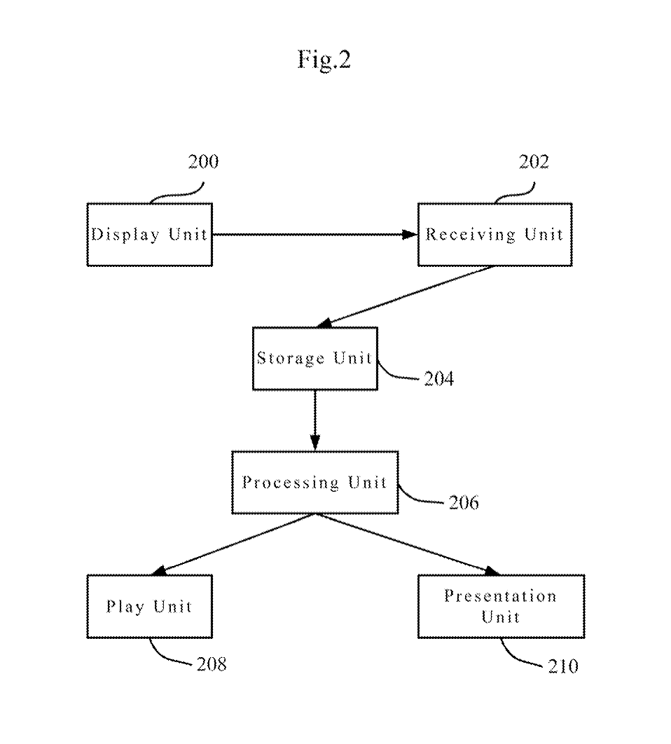

Now that the method for generating a voice signal of the E-book as an electronic bookmark has been illustrated with reference to FIG. 1, reference is made to FIG. 2 to discuss the E-book reader according to one embodiment of the invention. The system used for generating a voice signal to be used as an electronic bookmark can be more easily understood through the following description regarding the elements of the E-book reader.

FIG. 2 is a block diagram illustrating the E-book reader according to one embodiment of the present invention. As shown in FIG. 2, the E-book reader includes a display unit 200, a receiving unit 202, a storage unit 204 and a processing unit 206. The display unit 200 is operable to display contents of the E-book, and the receiving unit 202 is operable to receive the voice signal in response to a triggering signal for placing a bookmark. The voice signal is stored in the storage unit 204. The processing unit 206 is operable to display a functional icon of the bookmark corresponding to the stored voice signal at a position in adjacent to the current reading section of the E-book.

Furthermore, the E-book reader further comprises a play unit 208. After the functional icon corresponding to the stored voice signal is displayed at a position in adjacent to the current reading section of the E-book, the play unit 208 is operable to play said voice signal upon the selection of said functional icon.

According to another embodiment, the E-book reader further comprises a presentation unit 210. After the functional icon corresponding to the stored voice signal is displayed at a position in adjacent to the current reading section of the E-book, the presentation unit 210 is operable to present information corresponding to the voice signal upon the selection of said functional icon. For example, the information corresponding to the voice signal may be information about time when the voice signal is selected, a user who generates or causes the recording of the voice signal, or an importance level of the voice signal.

Next, discussion will be given with respect to the specific region of the E-book for displaying the functional icon(s) corresponding to the voice signal(s). In one example, a single electronic bookmark is corresponding to a specific position/region. In this case, the voice signal used as the electronic bookmark is referred to as a voice signal, and the processing unit 206 is operable to display a functional icon corresponding to the voice signal in said region via the display unit 200. In another example, multiple, say, two, electronic bookmarks may be corresponding to a specific position/region. In this case, when the second electronic bookmark corresponding to the region is created, a functional icon corresponding to a voice signal has been displayed in the region, and the processing unit 206 is operable to display the second functional icon in the region via display unit 200. It should be understood that, the receiving unit 202 receives the second voice signal in response to the triggering signal only when the functional icon has been displayed in the region. Also, the second functional icon may be corresponding to both the voice signal and the second voice signal. For example, the second functional icon may encompass the functional icon.

In one embodiment of the invention, the E-book reader further comprises a key/button. In this case, the receiving unit 202 begins to receive the voice signal when the button is pressed, and the storage unit 204 begins to store the voice signal when the button is pressed once again. In other words, the voice signal is respectively received and stored by the receiving unit 202 and the storage unit 204 when the button is pressed for the first and second times, respectively.

It is appreciated from the foregoing embodiments that the reader can record his/her own voice as the electronic bookmark at any time during the reading process by using the method for generating a voice signal in the E-book and the E-book reader provided herein. As such, the reader may timely record his/her remarks and thoughts in a convenient and swift way, as compared with the above-identified inconveniences encountered in the prior art. Moreover, the reader may insert/record his or her voice at any region of the E-book to create an electronic voice bookmark corresponding to the region. Also, the method and E-book reader provided herein may support other functions such as playback, sort/arrange, copy, search, delete and so on.

It will be understood that the above description of embodiments is given by way of example only. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for generating a voice signal in an electronic book (E-book), the method applicable to an E-book reader for displaying the E-book, and comprising the steps of:
receiving a voice signal in response to a triggering signal for placing a bookmark; and
displaying a functional icon of the bookmark corresponding to the voice signal in a region of the E-book.

2. The method according to claim 1, further comprising: after the step of displaying the functional icon in the region of the E-book, playing the voice signal when the functional icon is selected.

3. The method according to claim 1, further comprising: after the step of displaying the functional icon in the region of the E-book, presenting information corresponding to the voice signal when the functional icon is selected, wherein the information comprises information about time when the voice signal is recorded, a user who generates or causes the recording of the voice signal, or an importance level of the voice signal.

4. The method according to claim 1, further comprising receiving a second voice signal in response to a triggering signal after the functional icon is displayed in the region.

5. The method according to claim 4, further comprising displaying a second functional icon corresponding to the second voice signal in a region of the E-book.

6. The method according to claim 5, wherein the second functional icon corresponds to the voice signal and the second voice signal.

7. The method according to claim 5, wherein the second functional icon encompasses the functional icon.

8. The method according to claim 1, wherein the voice signal is received when a button on the E-book is pressed.

9. The method according to claim 8, wherein the step of receiving the voice signal comprises recording the voice signal when the button is pressed once again.

10. The method according to claim 1, wherein when the E-book is displayed on a touch screen of the E-book reader and the region of the E-book is clicked, the triggering signal is generated.

11. The method according to claim 1, wherein the step of receiving the voice signal comprises encoding and storing the voice signal.

12. An electronic book (E-book) reader, comprising:
a display unit for displaying an E-book;
a receiving unit for receiving a voice signal in response to a triggering signal for placing a bookmark; and
a processing unit for displaying a functional icon of the bookmark corresponding to the voice signal in a region of the E-book.

13. The E-book reader according to claim 12, further comprising:
a player for playing the voice signal when the functional icon is selected.

14. The E-book reader according to claim 12, further comprising:
a presentation unit for presenting information corresponding to the voice signal when the functional icon is selected, wherein the information comprises information about time when the voice signal is recorded, a user who generates or causes the recording of the voice signal, or an importance level of the voice signal.

15. The E-book reader according to claim 12, wherein the receiving unit is used to receive a second voice signal in response to a triggering signal after the functional icon is displayed in the region.

16. The E-book reader according to claim 15, wherein the display unit is used to display a second functional icon corresponding to the second voice signal in a region of the E-book.

17. The E-book reader according to claim 16, wherein the second functional icon corresponds to the voice signal and the second voice signal.

18. The E-book reader according to claim 16, wherein the second functional icon encompasses the functional icon.

19. The E-book reader according to claim 12, wherein when the E-book is displayed on a touch screen of the display unit and the region of the E-book is clicked, the triggering signal is generated.

20. The E-book reader according to claim 12, further comprising a recording unit for recording the voice signal.
